(19) United States
(12) Patent Application Publication
(10) Pub. No.: US 2025/0385339 A1
(43) Pub. Date: Dec. 18, 2025

(54) INTEGRATED HEATER FOR BATTERY

(71) Applicant: Tesla, Inc., Austin, TX (US)

(72) Inventors: Aaron Cheston Lim Ong, Colma, CA (US); Brennan Keegan, Sunnyvale, CA (US); Jochen Wilden, Aachen (DE); Timothy Murphy, San Francisco, CA (US); Abel Misrak, Rowlett, TX (US); Xue Hai Fang, San Jose, CA (US)

(21) Appl. No.: 18/745,849

(22) Filed: Jun. 17, 2024

(51) Int. Cl. H01M 10/6571; H01M 10/0525; H01M 10/42; H01M 10/48; H01M 10/615; H01M 10/625; H01M 10/637; H01M 10/653

(52) U.S. Cl. CPC H01M 10/6571; H01M 10/425; H01M 10/486; H01M 10/615; H01M 10/637; H01M 10/653; H01M 10/0525; H01M 2010/4271; H01M 10/625

(57) ABSTRACT

Aspects of this disclosure relate to a system for energy storage with integrated heating. The system can include a battery cell. The system can include a battery management board assembly coupled to the battery cell. The battery management board assembly can include a printed circuit board, an integrated circuit coupled to the printed circuit board and configured to monitor the battery cell, and an integrated heating element integrated with the printed circuit board and configured to heat the battery cell.

### BACKGROUND

### Technical Field

The disclosed technology generally relates to batteries. More specifically, embodiments of this disclosure relate to systems for heating a battery cell and related methods of heating a battery cell.

### Description of Related Technology

Rechargeable batteries are an integral component of energy-storage systems for electric vehicles and for grid storage (for example, for backup power during a power outage, as part of a microgrid, etc.). The performance of rechargeable batteries may be influenced by several factors, such as battery age, the level of charge in a battery, a temperature of a battery, and/or other factors. As rechargeable batteries may be subject to one or more of such factors at a given time, it may be desirable to include systems within the rechargeable batteries that can help reduce the effects on the batteries.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

In one aspect, the techniques described herein relate to a system for energy storage with integrated heating. The system can include a battery cell and a battery management board assembly coupled to the battery cell. The battery management board assembly can include a printed circuit board and an integrated circuit coupled to the printed circuit board. The integrated circuit can be configured to monitor the battery cell. The battery management board assembly can include an integrated heating element integrated with the printed circuit board. The integrated heating element can be configured to heat the battery cell.

In one embodiment, the integrated heating element includes a surface mount technology resistor.

In one embodiment, the battery cell includes a lithium-ion battery cell and a cell tab, the cell tab being thermally coupled with the integrated heating element.

In one embodiment, the system further includes a plurality of additional battery cells each including a respective cell tab. The battery management board assembly can further include a plurality of additional integrated heating elements, each of the plurality of additional integrated heating elements being in thermal contact with the respective cell tab of one of the plurality of additional battery cells.

In one embodiment, the system further includes thermal interface material positioned between the integrated heating element and the battery cell and configured to conduct heat from the integrated heating element to the battery cell.

In one embodiment, the battery cell includes a cell tab, and wherein the thermal interface material is positioned between the integrated heating element and the cell tab.

In one embodiment, the integrated heating element includes a resistive heater mounted on a side of the printed circuit board that is facing the battery cell.

In one embodiment, the integrated heating element and the integrated circuit are on opposite sides of the printed circuit board.

In one embodiment, the battery cell includes a lead-acid battery cell.

In one embodiment, the battery cell includes a pouch cell.

In one embodiment, the battery cell includes a cylindrical cell.

In one embodiment, the battery cell includes a prismatic cell.

In one embodiment, the system further includes a temperature sensor configured to sense a temperature associated with the battery cell. The battery management board assembly can be configured to activate the integrated heating element based on a signal from the temperature sensor.

In one embodiment, the temperature sensor is a negative temperature coefficient thermistor.

In one embodiment, the integrated circuit is configured to monitor a temperature associated with the battery cell, cause the heating element to heat to the battery cell in response to detecting that the temperature is below a first threshold, and cause the heating element to stop heating to the battery cell in response to detecting that the temperature is above a second threshold.

In one embodiment, the integrated circuit is configured to shut down the integrated heating element is response to detecting that the battery cell is disconnected.

In one aspect, the techniques described herein relate to a method of heating a battery pack. The method can include detecting that a temperature associated with a battery cell satisfies a threshold and heating the battery cell with a heater that is integrated on a battery management board coupled to the battery cell in response to the detecting. The heater can be on a side of the battery management board that is facing the battery cell. The battery management board can include an integrated circuit configured to monitor the battery cell.

In one embodiment, the method can further include deactivating the heater in response to detecting that the temperature exceeds a second threshold.

In one embodiment, the battery cell is a lithium-ion battery cell that is thermally coupled to the heater by way of thermal interface material and a cell tab of the battery cell.

In one aspects, the techniques described herein relate to a vehicle. The vehicle can include a vehicular electronics system, a plurality of battery cells configured to power the vehicular electronics system, and a battery management board assembly coupled to the plurality of battery cells. The battery management board assembly can include a printed circuit board and an integrated circuit configured to monitor the battery cells. The integrated circuit being on the printed circuit board. The battery management board assembly can include a plurality of integrated heating elements each configured to heat a respective battery cell of the plurality of battery cells. The plurality of integrated heating elements can be integrated with the printed circuit board.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will be described, by way of non-limiting example, with reference to the accompanying drawings.

FIGS. 1A, 1B, and 1C are schematic diagrams that illustrate an energy storage system with integrated heating according to embodiments.

FIGS. 2A, 2B, 2C, 2D, 2E, and 2F are schematic block diagrams that illustrate heat flow associated with heating a battery cell in an energy storage system according to embodiments.

FIG. 3 is a schematic block diagram of an example electric vehicle with an energy storage system can be implemented in accordance with embodiments.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings.

A “cell” or “battery cell” generally refers to an electrochemical cell, which is a device capable of generating electrical energy from chemical reactions or facilitating chemical reactions through the introduction of electrical energy. A battery can contain one or more cells. “Rechargeable battery” generally refers a type of electrical battery which can be charged, discharged into a load, and recharged a number of times. In this disclosure, a number of examples are described based on lithium-ion rechargeable batteries. Nevertheless, embodiments of the present invention are not limited to one type of rechargeable battery, and can be applied in conjunction with various rechargeable battery technologies.

Lithium-ion batteries can have degraded performance at certain low temperatures. For instance, lithium-ion batteries can have relatively high series resistance at low temperatures that can degrade performance. Electric vehicles with lithium-ion batteries can experience such performance degradation in cold weather conditions.

Aspects of this disclosure relate to actively heating and regulating battery performance in cold temperature conditions (e.g., sub-zero temperatures) by utilizing heating elements integrated with a battery management board. In certain embodiments, the integrated heating elements can be surface mount technology (SMT) resistors. The SMT resistors can conduct heat through thermal interface material (TIM) to transfer heat to the battery cells. In certain applications, TIM is in conductive contact with metal busbars, which have battery cell tabs welded thereon. A controller and/or firmware can cause the integrated heating elements to activate once a low temperature threshold is triggered.

Integrating heating elements on a battery management board assembly that also includes electronics to control battery cells can advantageously implement heating without separate heating components. The technical solutions to heating batteries under certain conditions disclosed herein can allow a smaller battery to meet battery performance specifications compared to systems without such heating.

Aspects of this disclosure relate to an integrated heater for a battery, such as a rechargeable battery. In certain embodiments, the integrated heater may be used to heat battery cells in an electric vehicle battery. An integrated heater can heat battery cells in any suitable battery in accordance with any suitable principles and advantages disclosed herein.

In some instances, a battery may benefit from an increased temperature in the battery cells. For example, low temperatures (e.g., subfreezing temperatures) can degrade the performance of and/or damage lithium-ion battery cells. Accordingly, integrated heaters disclosed herein can increase the performance of batteries, allow a smaller battery to meet battery performance specifications and/or extend the operational lifetime of the batteries.

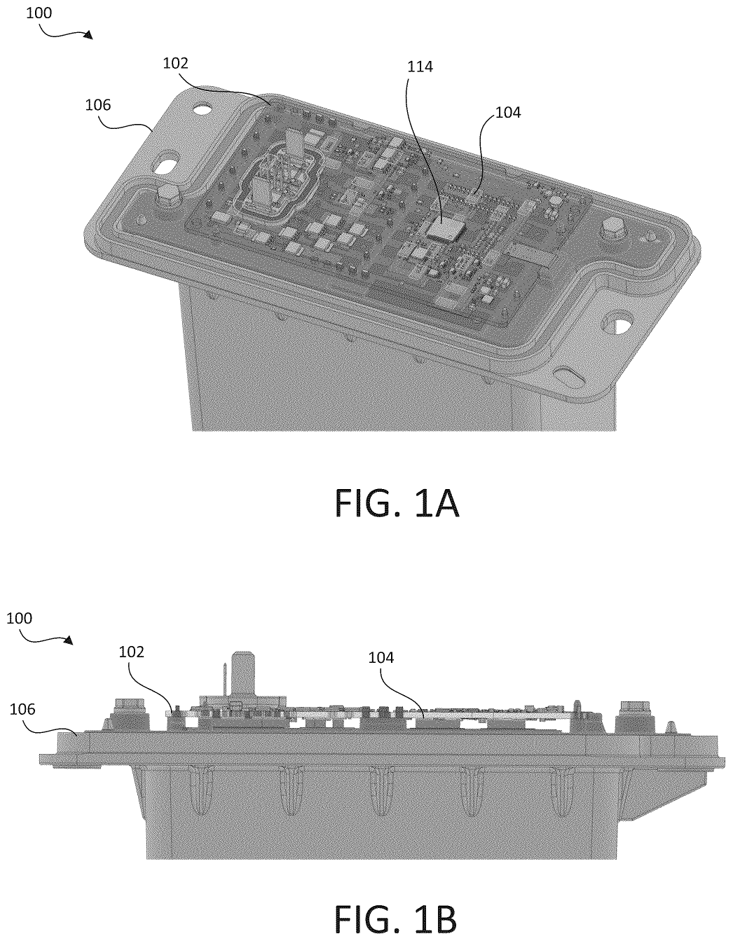

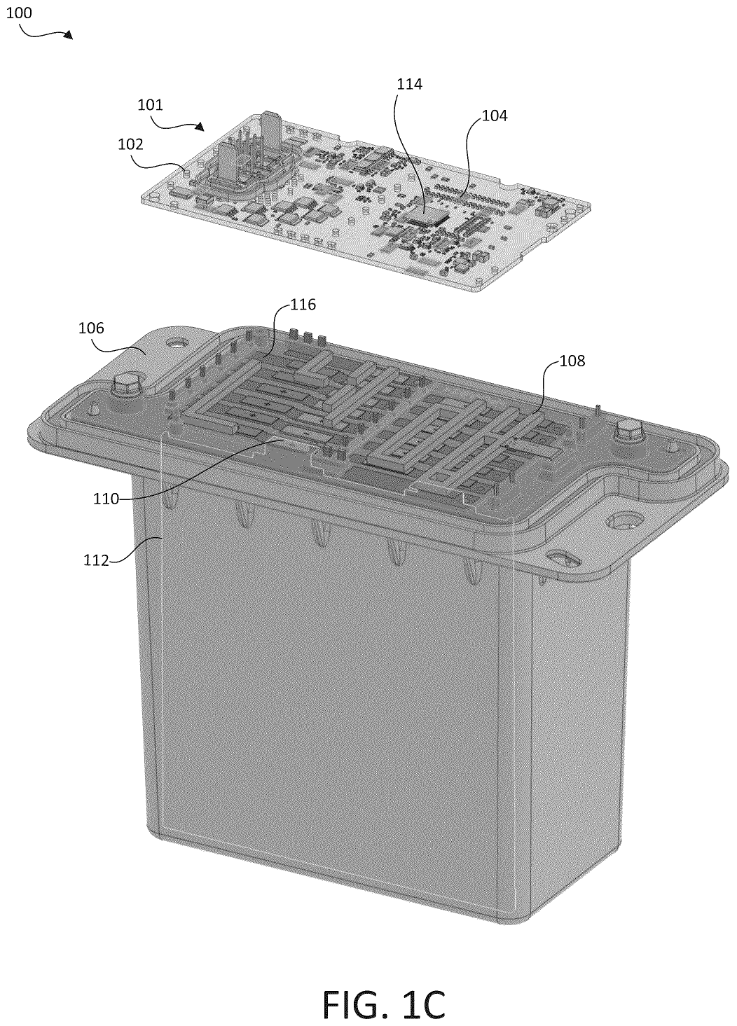

FIGS. 1A-1C illustrate an energy storage system 100 with integrated heating according to embodiments. The energy storage system 100 may be used in an electric vehicle in certain applications. The energy storage system 100 may be used in a hybrid vehicle in certain applications. In the illustrated embodiment, the energy storage system 100 includes a battery management board assembly 101 that includes a battery management board 102, an integrated circuit 114, and integrated heating elements 104. In the illustrated embodiment, the energy storage system 100 further includes a housing 106, thermal interface material 108, and battery cells 112 that include cell tabs 110.

The housing 106 can provide structural support and protection for the battery. In some embodiments, the housing 106 can be made of thermally and/or electrically insulating material. The battery cells 112 can be positioned within the housing 106 with electrical terminals accessible to the battery management board 102 and/or other electrical contacts. A battery pack can include the battery cells 112. The battery cells 112 can include individual cells configured to receive and/or deliver electrical charge, such as lithium-ion battery cells, lead-acid battery cells, and/or other suitable types of battery cells. In certain applications, the battery cells 112 are lithium-ion battery cells. The battery cells 112 can each include one or more cell tabs 110. In certain applications, each battery cell 112 can include a positive cell tab 110 and a negative cell tab 110. The cell tabs 110 can be welded to busbars 116.

A battery management board assembly 101 can include the battery management board 102 and components thereon and/or integrated therewith. For instance, a battery management board assembly 101 can include the battery management board 102, the integrated heating elements 104, and an integrated circuit 114 positioned on the battery management board 102. As illustrated, the heating elements 104 and the integrated circuit 114 can be on opposite sides of the battery management board 102. The battery management board assembly 101 can monitor and/or control one or more functions of the energy storage system 100. For instance, the battery management board assembly 101 can monitor and/or control the charging and discharging of electrical energy to and from the battery cells 112. The battery management board 102 can include one or more of a printed circuit board assembly (PCBA) or a flex printed circuit board (flex PCB). The battery management board assembly 101 can include the battery management board 102 and one or more integrated circuits (ICs) 114, such as one or more application specific ICs (ASICs) and/or other components to monitor and/or control the functions of the battery. The IC 114 of the battery management board assembly 101 can include any suitable circuitry to perform functionality for monitoring and/or controlling battery cells 112, such as but not limited to an ASIC, a microcontroller, a processor, etc. The IC 114 can be programmable in certain applications.

The integrated heating elements 104 can generate heat based on a control signal from the battery management board assembly 101. For example, in some instances, the integrated heating elements 104 are resistive heaters that generate heat as an electrical signal (e.g., electrical current) is applied to the integrated heating elements 104. In these instances, the battery management board assembly 101 can cause the integrated heating elements 104 to increase in temperature by applying an electrical signal to the integrated heating elements 104. With the integrated heating elements 104, the battery cells 112 can be heated by a battery management board assembly 101 without implementing separate heaters.

In the illustrated embodiment, the integrated heating elements 104 are surface mount technology (SMT) resistors mounted on the bottom of the battery management board 102. As illustrated, the bottom of the battery management board 102 is the side facing battery cells 112. The integrated heating elements 104 can include any other suitable heating elements. For example, the integrated heating elements 104 can include electrical traces, resistive traces, and/or other elements that can generate heat for heating a battery cell 112. The integrated heating elements 104 may positioned at any suitable positions on the battery management board 102 and/or be at least embedded in the battery management board. For example, the integrated heating elements 104 may be positioned on another side of the battery management board 102 and/or layered into the battery management board 102. In these examples, the battery management board 102 and/or the integrated heating elements 104 may include additional features to transfer heat from the battery management board 102 or the integrated heating elements 104, such as through holes and/or thermal vias.

The illustrated battery management board assembly 101 is coupled to the battery cells 112 (e.g., on the bottom side of the battery management board 102). As the integrated heating elements 104 generate heat, thermal energy may be transferred from the integrated heating elements 104 into the battery cells 112. In the illustrated embodiment, the thermal interface material 108 provides a thermal connection between the integrated heating elements 104 of the battery management board 102 to the cell tabs 110 of the battery cells 112. As such, as the integrated heating elements 104 increase in temperature, thermal energy is transferred from the integrated heating elements 104, through the thermal interface material 108 and the cell tabs 110 and into the battery cells 112 such that the battery cells 112 increase in temperature. The thermal interface material 108 can be positioned between the integrated heating elements 104 and the cell tabs 110. In some instances, a busbar 116 can be positioned between the cell tabs 110 and the battery cells 112, for example, as shown in FIG. 1C.

The thermal interface material 108 can include suitable thermally conductive materials, metal thermal interface materials, phase-change materials, thermally conductive pads, thermal adhesives, thermal pastes, or other suitable thermal interface materials. The thermal interface material 108 can increase the thermal conductivity from the integrated heating elements 104 to the cell tabs cell tabs 110. In some implementations, the thermal interface material 108 may be omitted and the integrated heating elements 104 may contact the cell tabs 110 directly. The cell tabs 110 may provide a thermal pathway to the battery cells 112. For example, in some implementations, the cell tabs 110 may be electrical terminals to the battery cells 112.

FIGS. 1A-1C illustrate the battery cells 112 as pouch cells with cell tabs 110. Battery cells can have other battery cell form factors in some other embodiments. For example, battery cells may be cylindrical cells, prismatic cells, or another suitable battery cell form factor in certain applications. Further, in some embodiments, the battery cells 112 may not have cell tabs 110. In these embodiments, heat may be transferred into the battery cells 112 directly and/or into other battery cell 112 components (e.g., into the cell can of a cylindrical cell).

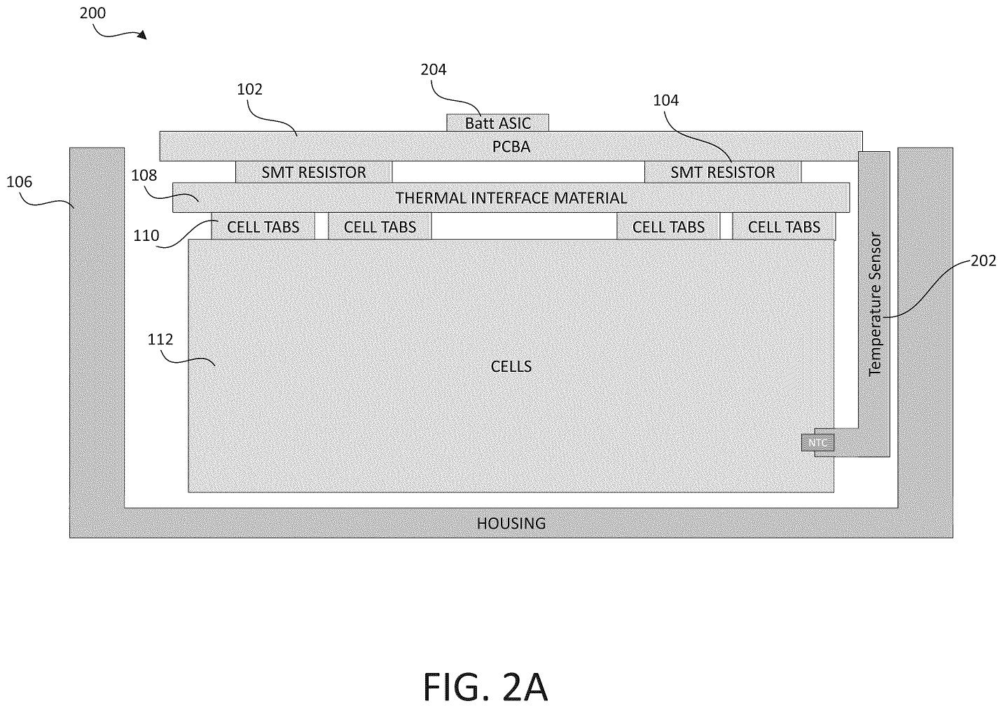

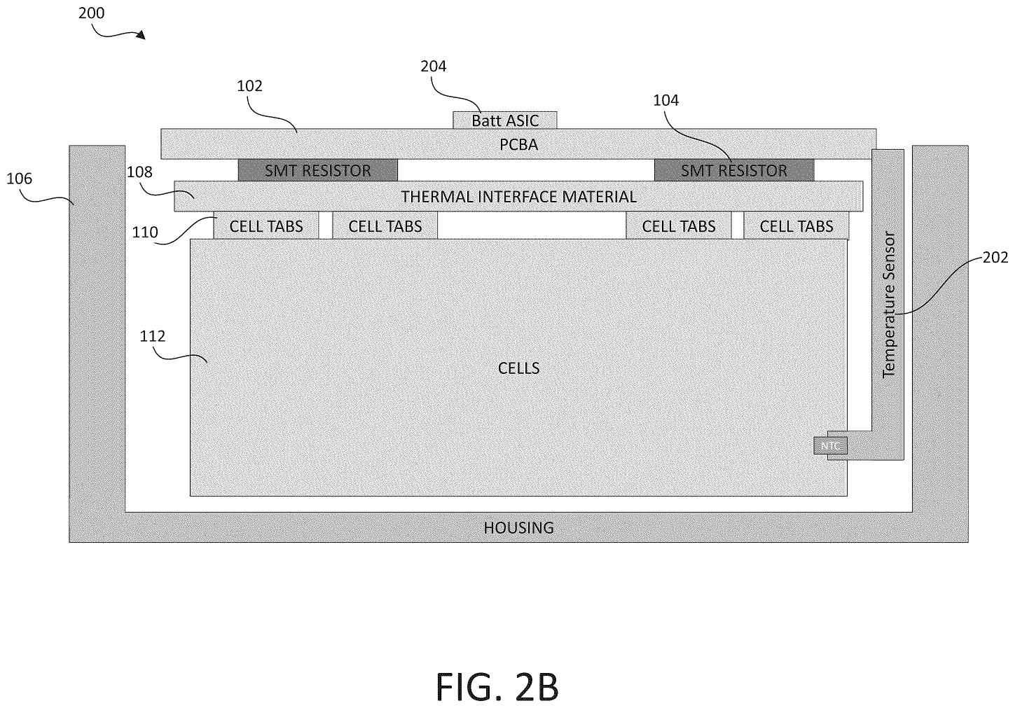

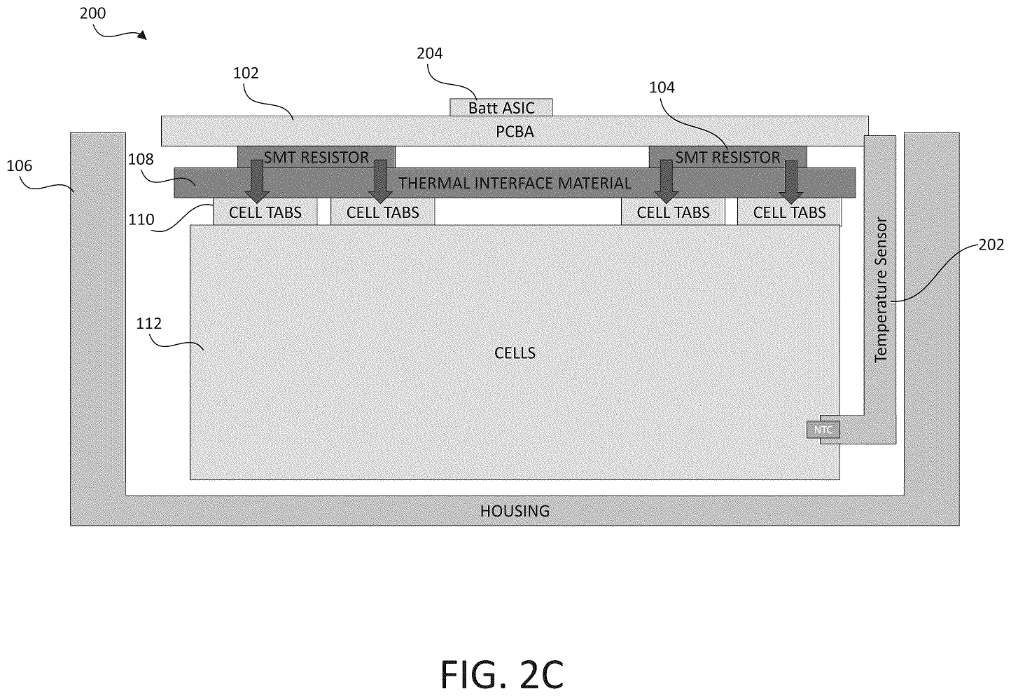

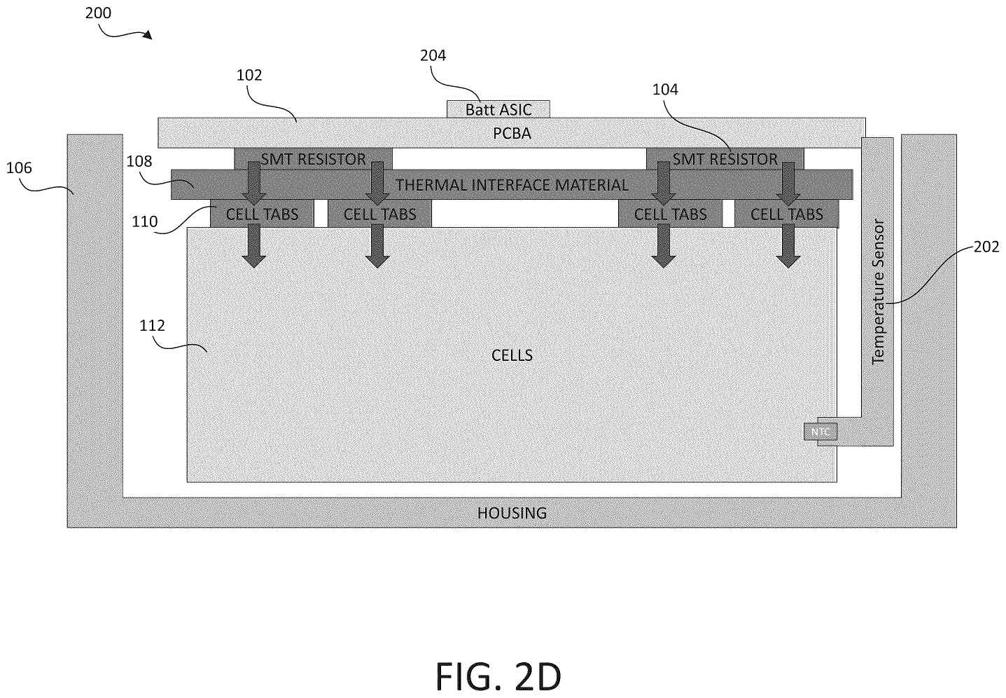

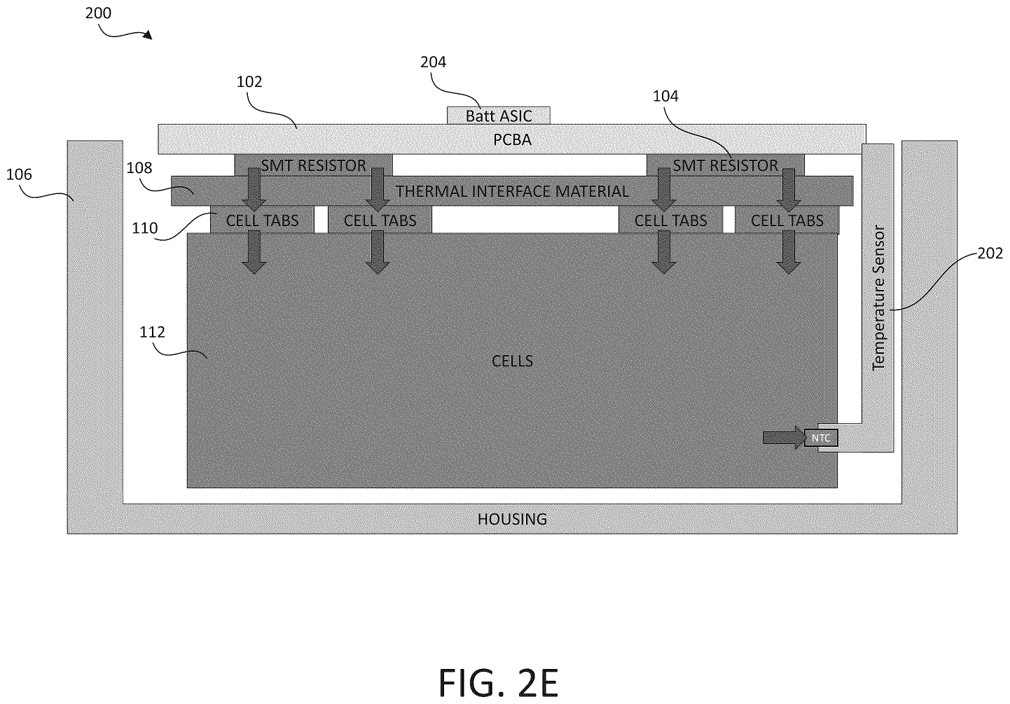

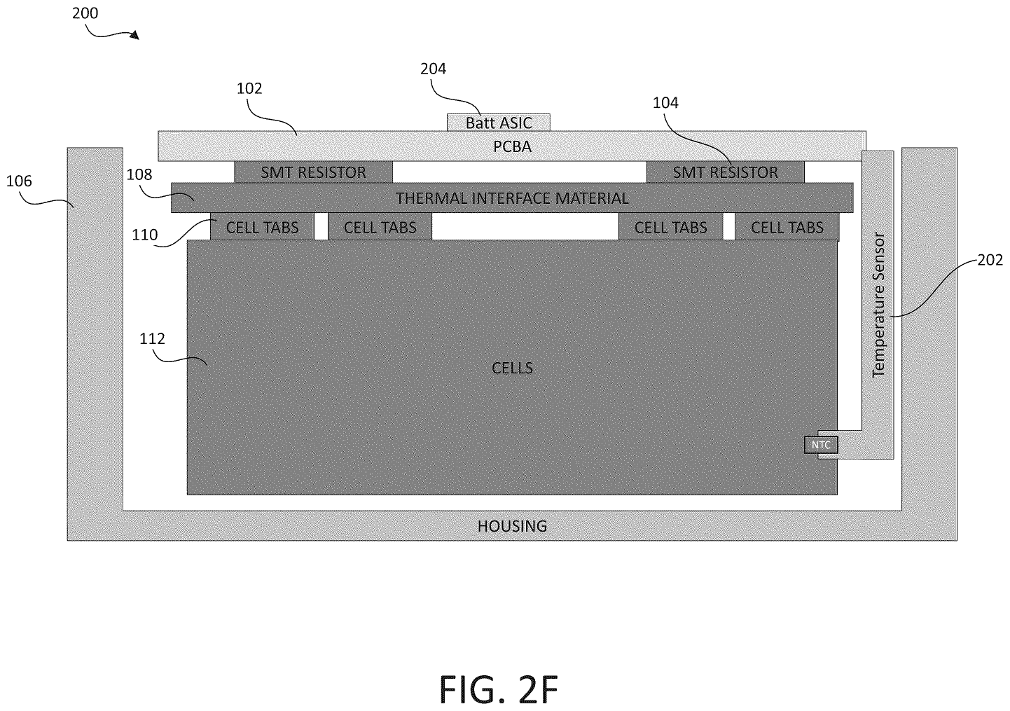

As described in more detail with respect to FIGS. 2A-2F, the battery can include and/or be in communication with thermal sensors, such as thermistors (e.g., negative temperature coefficient thermistors (NTCs)), thermocouples, thermal cameras, and/or other components configured to determine a temperature of the battery cells. The battery management board 102 may be in communication with the thermal sensors to monitor and/or control the integrated heating elements 104 based on a determined temperature of the battery cells 112. In some embodiments, no thermal sensors may be present. In these embodiments, the battery management board 102 may monitor and/or control the integrated heating elements 104 based on one or more control algorithms, signals received from a controller, or one or more other factors that may estimate the temperature of the battery cells 112 or otherwise determine when the integrated heating elements 104 are to be activated.

In some embodiments, when the battery cells 112 fall below a first threshold temperature, the battery management board assembly 101 can cause the integrated heating elements 104 to begin heating the battery cells 112. When the battery cells 112 exceed a second threshold temperature, the battery management board assembly 101 can cause the integrated heating elements 104 to stop transferring heat to the battery cells 112. Thresholds for heating and ceasing heating can be programmable and/or preset. By heating the battery cells 112 in cold weather conditions and/or other conditions with degraded performance, a battery pack can be smaller than without such heating and meet performance specifications for the battery pack. Advantageously, integrated heating elements 104 are integrated with the battery management board assembly 101 that is already present to monitor and/or control the battery cells 112.

In certain embodiments, the integrated heating elements 104 may be deactivated and/or prevented from transferring heat to the battery cells 112 based on one or more other trigger conditions. For example, if the battery is not connected to a charging and/or discharging source, the integrated heating elements 104 may be deactivated. This can involve shutting down the integrated heating elements 104 in response to detecting that a battery cell is disconnected. As another example, if a sufficiently high temperature is detected, the integrated heating elements 104 may be deactivated in case there is a failure in the integrated heating elements 104. This can prevent a failure where one or more integrated heating elements 104 stay on from being a cascading failure in the system. These trigger conditions can implement fail safes in the energy storage system. One or more trigger conditions can be programmed to the integrated circuit of the battery management board assembly and/or external control circuitry.

FIGS. 2A-2F illustrate block diagrams of an energy storage system 200 and heat flow for heating battery cells 112 of the energy storage system 200 according to embodiments. In the illustrated embodiment, the energy storage system 200 includes a housing 106, a battery management board 102 with integrated heating elements 104 and a battery ASIC 204, thermal interface material 108, cell tabs 110, battery cells 112, and a temperature sensor 202. The battery ASIC 204 can include circuitry for monitoring and/or controlling the battery cells 112 and/or other functionality of the battery management board assembly, such as those described with respect to integrated circuit 114 of FIGS. 1A-1C. In the illustrated embodiment, the battery ASIC 204 is coupled to the battery management board 102. In some embodiments, all, or a portion, of the operations described as performed by the battery ASIC 204 may be performed by another circuit, processor, controller, and/or the like and communicated to the battery management board 102.

The temperature sensor 202 can include any suitable sensor configured to detect a temperature of one or more of the battery cells 112. For example, the temperature sensor 202 can include one or more thermistors such as NTCs, thermocouples, thermal cameras, and/or the like. Using the temperature sensor 202, the energy storage system 200 can detect that a temperature associated with a battery cell 112 satisfies a threshold. Then the battery cell 112 can be heated with and an integrated heating element 104 in response to detecting that the temperature satisfies the threshold. In some embodiments, the battery may not include a temperature sensor 202. In these embodiments, the operations of the battery ASIC 204 may be determined based on estimated temperatures and/or one or more control algorithms.

FIG. 2A illustrates a battery in a resting or idle state. In this state, the integrated heating elements 104 are deactivated and not generating heat (in other words, the integrated heating elements 104 are off).

FIG. 2B illustrates the integrated heating elements 104 as being activated and beginning to generate heat. This can involve receiving an electrical signal from the battery management board 102 to cause the integrated heating elements 104 to increase in temperature (in other words, the integrated heating elements 104 are on). As illustrated in FIG. 2B, the shading of the integrated heating elements 104 is darker to indicate heat generation. In the illustrated embodiment, the battery ASIC 204 determined to heat the battery cells 112 and subsequently turned the integrated heating elements 104 on. For example, the battery ASIC 204 may receive a signal from the temperature sensor 202 and determine the battery cells 112 are at a temperature that is below a threshold temperature. The battery ASIC 204 can control a duty cycle of the integrated heating elements 104 based on an indication of temperature provided by the temperature sensor 202. For example, the duty cycle of the integrated temperature elements can be 100% when the temperature is well below the threshold temperature and the duty cycle can be lower than 100% when the temperature is closer to the threshold temperature.

FIG. 2C illustrates thermal energy transferring from the integrated heating elements 104, through the thermal interface material 108 and into the cell tabs 110. This can heat up the cell tabs 110. FIG. 2D illustrates thermal energy transferred from the cell tabs 110 into the battery cells 112. Heat can flow through each positive and negative cell tab 110 into the battery cells 112 in certain applications. FIG. 2E illustrates the battery cells 112 being heated from the thermal energy received via the cell tabs 110 and increasing in temperature. FIG. 2E further illustrates the temperature sensor 202 sensing an increase in temperature associated with the battery cells 112. The temperature sensor 202 can monitor temperature. The temperature sensor 202 can provide an electrical signal indicative of temperature to the battery management board 102. The temperature sensor 202 can be included in a closed loop. The temperature sensor 202 can be open loop modeled. In some instances, a plurality of temperature sensors 202 can be implemented and be in communication with circuitry of a battery management board assembly.

FIG. 2F illustrates the battery cells 112 heated to a desired temperature and the integrated heating elements 104 being turned off. For example, the battery ASIC 204 may receive a temperature reading from the temperature sensor 202 and determine the battery cells 112 are sufficiently heated. In response to this determination, the battery ASIC 204 can cause the integrated heating elements 104 to stop generating heat. This can involve applying an electrical signal to the integrated heating elements 104 to turn off the integrated heating elements 104. As the battery cells 112 cool, the battery ASIC 204 may receive updated temperature readings of the battery cells 112 from the temperature sensor 202 and determine to turn the integrated heating elements 104 back on (e.g., when the battery cells return to the state illustrated in FIG. 2A). As such, the states illustrated in FIGS. 2A-2F may be repeated as the temperature of the battery cells 112 increases and decreases.

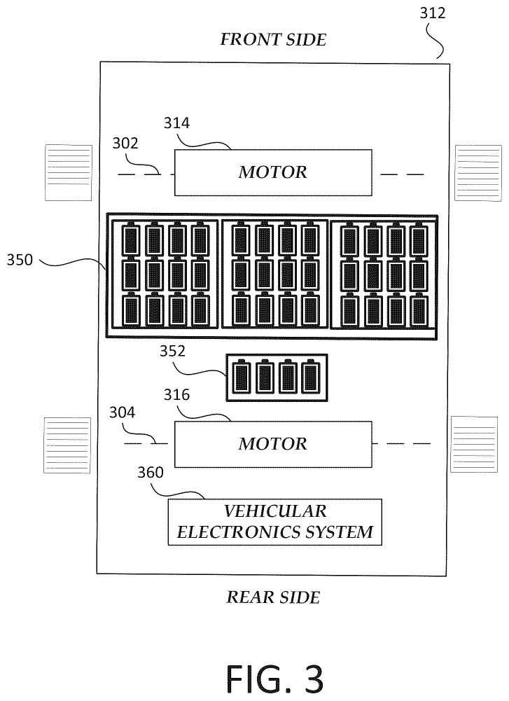

FIG. 3 illustrates an example electric vehicle 312 within which energy storage system 100 can be implemented in accordance with embodiments of the present disclosure. As shown in FIG. 3, the electric vehicle 312 includes a battery pack 350, a battery pack 352, a front axle 302, a rear axle 304, a motor 314, a motor 316, and a vehicular electronics system 360.

The battery pack 350 and/or the battery pack 352 can each include a plurality of battery cells, such as the battery cells 112 discussed above. For example, the battery pack 350 and/or the battery pack 352 may include hundreds or thousands of battery cells 112. Each of the battery cells 112 in the battery pack 350 and/or the battery pack 352 may be monitored and heated individually and/or in groups in accordance with any suitable principles and advantages discussed with reference to FIGS. 1A-1C and 2A-2F. Such heating may improve the performance of the battery pack 350, the battery pack 352, and/or the electric vehicle 312 in cold temperatures, extend the lifetime of the battery pack 350 and/or the battery pack 352, allow the use of a battery pack 350 and/or a battery pack 352 with fewer battery cells 112 and/or a smaller capacity, and/or provide other benefits to the electric vehicle 312, the battery pack 352, or the battery pack 350.

The motor 314 and/or the motor 316 may be electrically connected to the battery pack 350 and receive electrical power from the battery pack 350. For example, in some embodiments, the battery pack 350 is capable of delivering 900 Volts or more to the motor 314 and/or the motor 316. As another example, in some embodiments, the battery pack 350 is capable of delivering at least 300 Volts, at least or up to 400 Volts, at least or up to 700 Volts or at least or up to 800 Volts to the motor 314 and/or the motor 316. These examples are provided for illustrative purposes, and battery packs the battery pack 350 may be capable of delivering sufficient voltage and/or power to a motor for any suitable application in a vehicle.

Although FIG. 3 illustrates that the motor 314 deployed or attached to the electric vehicle 312 at the front axle 302 and the motor 316 deployed or attached to the electric vehicle 312 at the rear axle 304, it should be noted that in some implementations only one of the motor 314 or motor 316 may be deployed or attached to the electric vehicle 312. Further, in some implementations the motor 314 and/or the motor 316 may be otherwise deployed or attached to the electric vehicle 312. For example, both the motor 314 and the motor 316 may be deployed or attached to the same axle (e.g., the front axle 302 or the rear axle 304) or one or both the motor 314 and 316 may be deployed or attached elsewhere in the electric vehicle 312 and otherwise connected to the front axle 302 or the rear axle 304. In some instances, an electric vehicle can include more than 2 motors. In some other instances, an electric vehicle can include a single motor.

The vehicular electronics system 360 may be electrically connected to the battery pack 352 and receive electrical power from the battery pack 352. The vehicular electronics system 360 may be system that can control one or more of vehicle lights, wipers, airbags, consoles, multimedia components, electric window openers, climate controls, and/or any other suitable functions controlled by low voltage battery cells, such as battery cells of the battery pack 352. For example, in some embodiments, the battery pack 352 is capable of delivering 48 Volts or more to the vehicular electronics system 360. As another example, in some embodiments, the battery pack 352 is capable of delivering at least or up to 12 Volts to the vehicular electronics system 360 or at least or up to 24 Volts to the vehicular electronics system 360. These examples are provided for illustrative purposes, and battery packs such as the battery pack 352 may be capable of delivering sufficient voltage and/or power to the vehicular electronics system 360 for any suitable application in a vehicle.

In some embodiments, battery pack 352 may be omitted (or part of the battery pack 350) and the vehicular electronics system 360 may be electrically connected to the battery pack 350 and receive electrical power from the battery pack 350. In these embodiments, the battery pack 350, the vehicular electronics system 360, and/or the electric vehicle 312 may include components to convert a high voltage (e.g., 900 Volts, 800 Volts, 700 Volts, 400 Volts, 300 Volts, or another high voltage) to a lower voltage (e.g., 12 Volts, 24 Volts, 48 Volts, or another low voltage). For example, the battery pack 350, the vehicular electronics system 360, and/or the electric vehicle 312 can include one or more power converting circuits.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Thus, although the various schematics shown in the figures depict example arrangements of elements and components, additional intervening elements, devices, features, or components may be present in an actual embodiment (assuming that the functionality of the depicted circuits is not adversely affected). Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the embodiments provided herein can be applied to other systems, not necessarily the systems described above. The elements and acts of the various embodiments described above can be combined to provide further embodiments. The acts of any methods discussed herein can be performed in any order as appropriate. Moreover, the acts of any methods discussed herein can be performed serially or in parallel, as appropriate.

While certain embodiments of the inventions have been described, these embodiments have been presented by way of example only, and are not intended to limit the scope of the disclosure. Indeed, the novel circuits, methods, and systems described herein may be embodied in a variety of other forms. Furthermore, various omissions, substitutions and changes in the form of the circuits, methods, apparatus and systems described herein may be made without departing from the spirit of the disclosure. For example, while the disclosed embodiments are presented in given arrangements, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure. Accordingly, the scope of the present inventions is defined by reference to the claims.

What is claimed is:

1. A system for energy storage with integrated heating, the system comprising:
a battery cell; and
a battery management board assembly coupled to the battery cell, the battery management board assembly comprising:
a printed circuit board;
an integrated circuit coupled to the printed circuit board, the integrated circuit configured to monitor the battery cell; and
an integrated heating element integrated with the printed circuit board, the integrated heating element configured to heat the battery cell.

2. The system of claim 1, wherein the integrated heating element comprises a surface mount technology resistor.

3. The system of claim 2, wherein the battery cell comprises a lithium-ion battery cell and a cell tab, the cell tab being thermally coupled with the integrated heating element.

4. The system of claim 1, further comprising a plurality of additional battery cells each comprising a respective cell tab, wherein the battery management board assembly further comprises a plurality of additional integrated heating elements, each of the plurality of additional integrated heating elements being in thermal contact with the respective cell tab of one of the plurality of additional battery cells.

5. The system of claim 1, further comprising thermal interface material positioned between the integrated heating element and the battery cell and configured to conduct heat from the integrated heating element to the battery cell.

6. The system of claim 5, wherein the battery cell comprises a cell tab, and wherein the thermal interface material is positioned between the integrated heating element and the cell tab.

7. The system of claim 1, wherein the integrated heating element comprises a resistive heater mounted on a side of the printed circuit board that is facing the battery cell.

8. The system of claim 1, wherein the integrated heating element and the integrated circuit are on opposite sides of the printed circuit board.

9. The system of claim 1, wherein the battery cell comprises a lead-acid battery cell.

10. The system of claim 1, wherein the battery cell comprises a pouch cell.

11. The system of claim 1, wherein the battery cell comprises a cylindrical cell.

12. The system of claim 1, wherein the battery cell comprises a prismatic cell.

13. The system of claim 1, further comprising a temperature sensor configured to sense a temperature associated with the battery cell, wherein the battery management board assembly is configured to activate the integrated heating element based on a signal from the temperature sensor.

14. The system of claim 13, wherein the temperature sensor is a negative temperature coefficient thermistor.

15. The system of claim 1, wherein the integrated circuit is configured to:
monitor a temperature associated with the battery cell;
cause the integrated heating element to heat to the battery cell in response to detecting that the temperature is below a first threshold; and
cause the integrated heating element to stop heating to the battery cell in response to detecting that the temperature is above a second threshold.

16. The system of claim 1, wherein the integrated circuit is configured to shut down the integrated heating element is response to detecting that the battery cell is disconnected.

17. A method of heating a battery pack, the method comprising:
detecting that a temperature associated with a battery cell satisfies a threshold; and
heating the battery cell with a heater that is integrated on a battery management board coupled to the battery cell in response to the detecting,
wherein the heater is on a side of the battery management board that is facing the battery cell, wherein the battery management board comprises an integrated circuit configured to monitor the battery cell.

18. The method of claim 17, further comprising deactivating the heater in response to detecting that the temperature exceeds a second threshold.

19. The method of claim 17, wherein the battery cell is a lithium-ion battery cell that is thermally coupled to the heater by way of thermal interface material and a cell tab of the battery cell.

20. A vehicle comprising:
a vehicular electronics system;
a plurality of battery cells configured to power the vehicular electronics system; and
a battery management board assembly coupled to the plurality of battery cells, the battery management board assembly comprising:
a printed circuit board;
an integrated circuit configured to monitor the plurality of battery cells, the integrated circuit being on the printed circuit board; and
a plurality of integrated heating elements each configured to heat a respective battery cell of the plurality of battery cells, the plurality of integrated heating elements being integrated with the printed circuit board.
